(19) United States
(12) Patent Application Publication
(10) Pub. No.: US 2026/0288826 A1
(43) Pub. Date: Sep. 24, 2026

(54) GENERATIVE ARTIFICIAL INTELLIGENCE ROBUSTNESS TO UNSTRUCTURED PROMPTS

(71) Applicant: International Business Machines Corporation, Armonk, NY (US)

(72) Inventors: Vagner Figueredo de Santana, White Plains, NY (US); Rachel Ostrand, White Plains, NY (US); Muneeza Azmat, Mohegan lake, NY (US)

(21) Appl. No.: 19/082,558

(22) Filed: Mar. 18, 2025

(51) Int. Cl. G06F 16/3332; G06F 16/334

(52) U.S. Cl. CPC G06F 16/3334; G06F 16/334

(57) ABSTRACT

According to one embodiment, a method, computer system, and computer program product for improving robustness of a large language model (LLM) is provided. The embodiment may include receiving a set of user prompts to the LLM; generating, via the LLM, a respective associated response to each user prompt; determining a user-approved, associated response to a final user prompt; defining a respective tuple mapping for each user prompt to the user-approved, associated response; generating, via the LLM, an internal prompt representation of the final user prompt using a topic-guided reverse prompt; generating, via the LLM, an associated response to the internal prompt representation; defining respective tuple mappings for the internal prompt representation to the user-approved, associated response and to the associated response; defining a respective tuple mapping for each user prompt to the associated response; and fine-tuning the LLM based on defined tuple mappings.

### BACKGROUND

The present invention relates generally to the field of computing, and more particularly to generative artificial intelligence (GenAI) and large language models (LLMs).

Generative artificial intelligence is a type of artificial intelligence that can create new content, such as text, images, music, video, and code, based on patterns learned from vast amounts of training data. Rather than simply analyzing or classifying information, GenAI produces original outputs that resemble human-generated content. Large language models are a subset of GenAI which are designed to process natural language tasks and generate text-based content. LLMs are built using deep learning practices (i.e., transformer-based architectures) and are trained using self-supervised learning on massive amounts of data to understand natural language prompts and generate human-like text. These models can then be fine-tuned for specific tasks or guided by prompt engineering. Prompt engineering is the process of crafting effective input prompts to guide LLMs in generating desired outputs (i.e., accurate and useful responses). As an LLM responds based on its training data and probability-based predictions, a well-structured prompt can significantly improve accuracy and relevance of the responses.

### SUMMARY

According to one embodiment, a method, computer system, and computer program product for improving robustness of a large language model (LLM) is provided. The embodiment may include receiving a set of user prompts to the LLM. The embodiment may include generating, via the LLM, a respective associated response to each user prompt of the set. The embodiment may include determining a user-approved, associated response to a final user prompt of the set. The embodiment may include defining a respective tuple mapping for each user prompt of the set to the user-approved, associated response. The embodiment may include extracting one or more topic-related keywords from the final user prompt. The embodiment may include generating, via the LLM, an internal prompt representation of the final user prompt using a topic-guided reverse prompt. The embodiment may include generating, via the LLM, an associated response to the internal prompt representation. The embodiment may include defining respective tuple mappings for the internal prompt representation to the user-approved, associated response and to the associated response. The embodiment may include defining a respective tuple mapping for each user prompt of the set to the associated response. The embodiment may include fine-tuning the LLM based on defined tuple mappings.

### BRIEF DESCRIPTION OF THE SEVERAL VIEWS OF THE DRAWINGS

These and other objects, features and advantages of the present invention will become apparent from the following detailed description of illustrative embodiments thereof, which is to be read in connection with the accompanying drawings. The various features of the drawings are not to scale as the illustrations are for clarity in facilitating one skilled in the art in understanding the invention in conjunction with the detailed description. In the drawings:

FIG. 1 illustrates an exemplary computer environment according to at least one embodiment.

FIG. 2 illustrates an operational flowchart for improving robustness of a large language model in response to less or unstructured prompts via an unstructured prompt robustness improvement process according to at least one embodiment.

### DETAILED DESCRIPTION

Detailed embodiments of the claimed structures and methods are disclosed herein; however, it can be understood that the disclosed embodiments are merely illustrative of the claimed structures and methods that may be embodied in various forms. This invention may, however, be embodied in many different forms and should not be construed as limited to the exemplary embodiments set forth herein. In the description, details of well-known features and techniques may be omitted to avoid unnecessarily obscuring the presented embodiments.

It is to be understood that the singular forms “a,” “an,” and “the” include plural referents unless the context clearly dictates otherwise. Thus, for example, reference to “a component surface” includes reference to one or more of such surfaces unless the context clearly dictates otherwise.

The present invention relates generally to the field of computing, and more particularly to generative artificial intelligence (GenAI) and large language models (LLMs). The following described exemplary embodiments provide a system, method, and program product to, among other things, unpack different prompt structures of users of an LLM, expected/approved LLM responses, and prompt structures expected by the LLM to fine-tune the LLIM so that less structured prompts of a user may lead to responses similar to those obtained when using well-structured prompts. Therefore, the present embodiment has the capacity to improve the technical field of LLMs by using reverse prompting to fine-tune an LLM such that it may be re-instructed based on less structured prompts and approved previous LLM responses, thus overcoming user reliance on well-structured prompts to obtain an approved response by enabling the LLM to learn different ways for writing prompts and reducing the number of prompt iterations by the user to obtain an expected/approved LLM response.

As previously described, generative artificial intelligence is a type of artificial intelligence that can create new content, such as text, images, music, video, and code, based on patterns learned from vast amounts of training data. Rather than simply analyzing or classifying information, GenAI produces original outputs that resemble human-generated content. Large language models are a subset of GenAI which are designed to process natural language tasks and generate text-based content. LLMs are built using deep learning practices (i.e., transformer-based architectures) and are trained using self-supervised learning on massive amounts of data to understand natural language prompts and generate human-like text. These models can then be fine-tuned for specific tasks or guided by prompt engineering. Prompt engineering is the process of crafting effective input prompts to guide LLMs in generating desired outputs (i.e., accurate and useful responses). As an LLM responds based on its training data and probability-based predictions, a well-structured prompt can significantly improve accuracy and relevance of the responses.

Prompt engineering, or prompting, is commonly implemented as GenAI often fails in detecting nuances and individual preferences (e.g., prompting styles & structures) of users while they are communicating with an LLM using natural language. Generally, this failure results from a lack of presence of similar user-specific nuances and preferences within data used to train the LLM. As such, prompt engineering has been developed as a technique to combat this problem by proposing prompting templates and/or prompting styles which are intended to help users produce well-structured prompts which lead to desired LLM outputs. However, composing a good (i.e., well-structured) prompt to achieve a desired/expected result may remain challenging and cumbersome for a user. For instance, through prompting, the user may be required to submit multiple iterations of prompts to the LLM, manually refining/altering their prompt with each iteration, to eventually obtain a successful prompt-result pair, i.e., to eventually compose a prompt that returns the type of LLM response the user is expecting. It may therefore be imperative to have an unstructured prompt robustness system in place to reduce user reliance on prompt engineering practices (e.g., iterating on prompts and/or use of prompt templates), and improve an LLM's functionality in generating a user desired output in response to an unstructured or less structured prompt by the user. Thus, embodiments of the present invention may be advantageous to, among other things, receive iterations of user prompts to an LLM, identify an approved LLM response (i.e., output) to a user prompt based on explicit or implicit user feedback, extract one or more topic-related keywords from a prompt associated with an approved LLM response, register/store a complete prompt-output tuples history/graph of a user interaction with an LLM, create and store mappings of tuples containing previous user prompts (e.g., less structured prompts) of an LLM interaction and approved LLM responses, utilize reverse prompting to produce one or more system-generated prompt representations expected by an LLM in terms of structure and based on reverse prompt input including one or more topic-related keywords and an approved LLM output, utilize one or more natural language processing (NLP) techniques to determine similarity among prompts, prompt an LLM using a system-generated prompt to receive an expected LLM response, re-instruct an LLM based on mappings (i.e., tuples) of less structured user prompts to approved/expected LLM responses and mappings of system-generated prompt representations to approved/expected LLM responses, and deploy a re-instructed LLM for improved generation of responses to less structured prompts. The present invention does not require that all advantages need to be incorporated into every embodiment of the invention.

According to at least one embodiment, an unstructured prompt robustness (UPR) program may operate as an LLM which generates an NLP response (“response”) to a submitted NLP prompt (“prompt”). According to at least one embodiment, the UPR program may receive feedback from a user which indicates user approval of a UPR generated response to a prompt submitted by the user. The prompt may be identified as a successful prompt (i.e., a prompt which resulted in a user-approved response) and may be preceded by a set of one or more previous prompts submitted by the user, where each previous prompt of the set may be a less structured and different iteration of the successful prompt and did not result in a user-approved response. According to at least one embodiment, the UPR program may define respective prompt-response tuple mappings (i.e., pairings) for each previous prompt of the set to the user-approved response and for the successful prompt to the user-approved response. According to at least one embodiment, the UPR program may also extract one or more topic-related keywords from the successful prompt. Furthermore, the UPR program may generate, via an internal topic-guided reverse prompt, an internal representation of the successful prompt, where input to the topic-guided reverse prompt includes the one or more topic-related keywords and the user-approved response. Moreover, the UPR program may generate a response associated with, and in response to, the internal representation of the successful prompt. The UPR program may further define respective prompt-response tuple mappings for each previous prompt of the set to the generated response associated with the internal representation of the successful prompt and for the internal representation of the successful prompt to its associated response. According to at least one embodiment, the UPR program may fine-tune its LLM based on the defined prompt-response tuple mappings.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random-access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

The following described exemplary embodiments provide a system, method, and program product to improve robustness (e.g., ability to provide desired and/or useful responses) of an LLM in response to unstructured or less structured prompts.

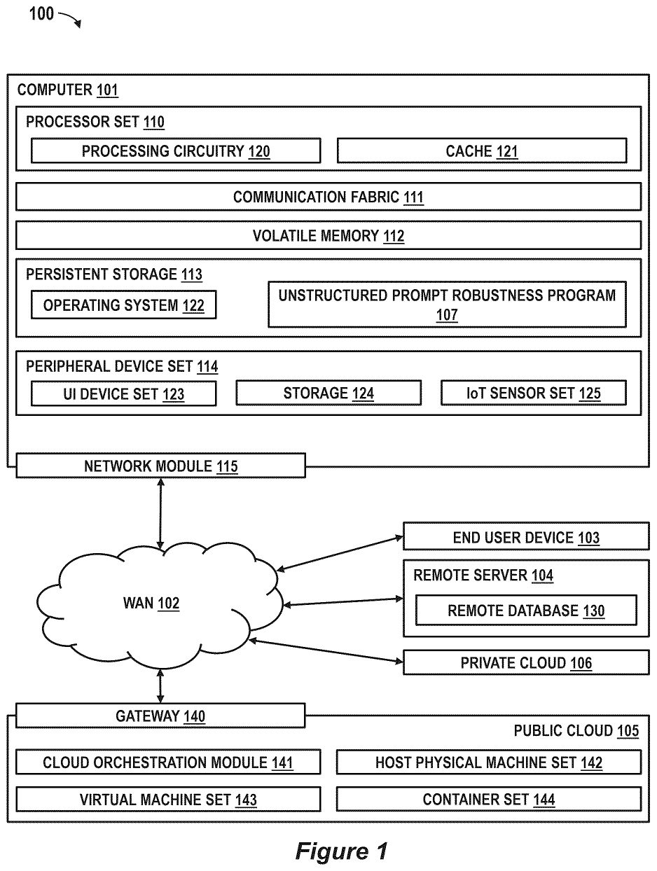

Referring to FIG. 1, an exemplary computing environment 100 is depicted, according to at least one embodiment. Computing environment 100 contains an example of an environment for the execution of at least some of the computer code involved in performing the inventive methods, such as unstructured prompt robustness (UPR) program 107. In addition to UPR program 107, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and UPR program 107), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

Computer 101 may take the form of a desktop computer, laptop computer, tablet computer, smartphone, smart watch or other wearable computer, mainframe computer, quantum computer or any other form of computer or mobile device now known or to be developed in the future that is capable of running a program and accessing a network or querying a database, such as remote database 130. Additionally, computer 101 may be any other form of computer or mobile device now known or to be developed in the future that is enabled to perform generative AI functions using a large language model. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

Processor set 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in UPR program 107 within persistent storage 113.

Communication fabric 111 is the signal conduction paths that allow the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

Volatile memory 112 is any type of volatile memory now known or to be developed in the future. Examples include dynamic type random access memory (RAM) or static type RAM. Typically, the volatile memory is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

Persistent storage 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid-state storage devices. Operating system 122 may take several forms, such as various known proprietary operating systems or open-source Portable Operating System Interface type operating systems that employ a kernel. The code included in UPR program 107 typically includes at least some of the computer code involved in performing the inventive methods.

Peripheral device set 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion type connections (for example, secure digital (SD) card), connections made through local area communication networks and even connections made through wide area networks such as the internet. In various embodiments, UI device set 123 may include components such as a display screen, speaker, microphone, wearable devices (such as smart glasses, smart watches, AR/VR-enabled headsets, and wearable cameras), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer, another sensor may be a motion detector, another sensor may be a global positioning system (GPS) receiver, and yet another sensor may be a digital image capture device (e.g., a camera) capable of capturing and transmitting one or more still digital images or a stream of digital images (e.g., digital video).

Network module 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

End user device (EUD) 103 is any computer system that is used and controlled by an end user (for example, a client of an enterprise that operates computer 101), and may take any of the forms (and possess any of the technical capabilities) discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on. According to at least one other embodiment, in addition to taking any of the forms discussed above with computer 101, EUD 103 may further be an IoT-enabled device capable of performing generative AI functions using a large language model, and capable of receiving instructions from UPR program 107. Although only a single EUD 103 is depicted, computing environment 100 may include a plurality of EUDs 103.

Remote server 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

Public cloud 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

Private cloud 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

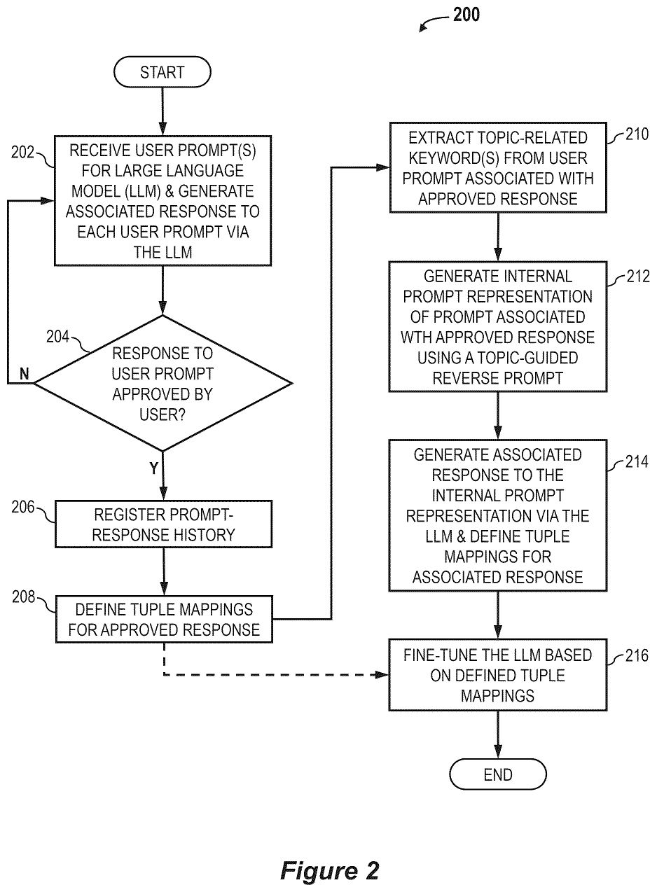

The UPR program 107 may be a program capable of receiving iterations of user prompts to an LLM, identifying an approved LLM response (i.e., output) to a user prompt based on explicit or implicit user feedback, extracting one or more topic-related keywords from a prompt associated with an approved LLM response, registering/storing a complete prompt-output tuples history/graph of a user interaction with an LLM, defining and storing mappings of tuples containing previous user prompts (e.g., less structured prompts) of an LLM interaction and approved/expected LLM responses, utilizing reverse prompting to produce one or more system-generated prompt representations expected by an LLM in terms of structure and based on reverse prompt input including one or more topic-related keywords and an approved LLM output, utilizing one or more natural language processing (NLP) techniques to determine similarity among prompts, prompting an LLM using a system-generated prompt to receive an expected LLM response, re-instructing an LLM based on mappings (i.e., tuples) of less structured user prompts to approved/expected LLM responses and mappings of system-generated prompt representations to approved/expected LLM responses, and deploying a re-instructed LLM for improved generation of responses to less structured prompts. In at least one embodiment, UPR program 107 may require a user to opt-in to system usage upon opening or installation of UPR program 107. Notwithstanding depiction in computer 101, UPR program 107 may be stored in and/or executed by, individually or in any combination, end user device 103, remote server 104, public cloud 105, and private cloud 106 so that functionality may be separated among the devices. The unstructured prompt robustness method is explained in further detail below with respect to FIG. 2.

Referring now to FIG. 2, an operational flowchart for improving robustness of a large language model in response to less or unstructured prompts via an unstructured prompt robustness improvement process 200 is depicted according to at least one embodiment. At 202, UPR program 107 receives one or more user prompts for an LLM and generates an associated response to each user prompt via the LLM. According to at least one embodiment, UPR program 107 may implement an LLM which generates an NLP response (“response”) to a submitted NLP prompt (“prompt”). In this step, the prompt(s) submitted by the user may potentially be unstructured or less structured (e.g., a prompt which differs in terms of structure from a prompt used to fine-tune/re-instruct base models or a prompt which is broad and/or unclear in its request) and may therefore cause UPR program 107 to generate a response which is undesirable (e.g., inaccurate or not useful) to the user. Consequently, the user may submit a set of multiple iterations of their prompt to UPR program 107, refining their prompt with each iteration, to arrive at a generated response which is user-approved. For example, in a given interaction, the user may submit the following prompts (Pₙ) to UPR program 107 and receive the following respectively associated responses (Rₙ):
P1: Tell me how to do audience research and create personas.
R1: Sure, I'd be happy to help you with that! Audience research and persona creation are essential in creating effective marketing.
P2: List the steps on how to do audience research and create personas.
R2: Sure, I'd be happy to help you with that! Audience research and persona creation are essential steps in creating effective marketing.
P3: List the steps for conducting audience research, followed by a guide on creating customer personas.
R3: Sure, here are the steps for conducting audience research: 1. Define your objectives: Clearly outline what you hope to achieve through your research. This could include understanding your target audience better, identifying new market opportunities, or testing product concepts. 2 . . . .

As can be seen in the above example, the user refines their prompts, from an initial prompt P1 to a final prompt P3, i.e., from a poorly stylized and unclear request to a well-structured and clear request, thus enabling UPR program 107 to better interpret the request and provide the correct information. However, note that it took the user two previous prompt submissions/iterations (P1 and P2) before they crafted the final prompt P3 which was successful in that it returned a result desired by the user.

Next, at 204, UPR program 107 determines whether a generated response to an associated prompt has been approved by the user. UPR program 107 may determine that the user has approved a generated response upon receiving an indication of approval from the user which signals that the generated response contains desired content. According to at least one embodiment, UPR program 107 may receive an indication of user approval of the response via an explicit action of the user. For example, the user may submit a textual input to UPR program 107, such as “Thank you”, in response to the generated response. As another example, the user may interact with a user interface (UI) feature of UPR program 107, such as a thumbs-up or star marker, to indicate their approval of the generated response. According to another embodiment, UPR program 107 may receive an indication of user approval of the response via an implicit action of the user such as assessing user consumption of the generated response. For example, an indication of user approval may be received where UPR program 107 has identified a download of the generated response, a copy & pasting of the generated response, or where UPR program 107 has assessed a user reading speed of the generated response at or below a specified threshold, or time spent interacting with the model's response, as measured by, e.g., mouse-tracking data. In response to determining that a generated response to an associated prompt has been approved by the user (step 204, “Y” branch), the unstructured prompt robustness improvement process 200 may proceed to step 206. In response to determining that a generated response to an associated prompt has not been approved by the user (step 204, “N” branch), i.e., an indication of approval from the user has not been received or explicit negative feedback from the user has been received (e.g., UI thumbs-down marker), the unstructured prompt robustness improvement process 200 may return to step 202. In continuation of the above interaction example, UPR program 107 may receive an indication of user approval of generated response R3, which is associated with prompt P3, as a result of the user providing a textual “thank you” or a UI thumbs-up marker in response to the generated response R3.

At 206, in response to determining that a generated response to an associated prompt has been approved by the user, UPR program 107 registers the prompt-response history resulting from the user interaction with UPR program 107 in step 202. According to at least one embodiment, the prompt-response history of the user's interaction with UPR program 107 may include multiple user prompts, and their respectively associated generated responses, as initial prompts of the user may have been less structured and required subsequent refinements and iterations before arriving at a user prompt (e.g., a final user prompt) which produced a generated response approved by the user. In registering the prompt-result history, UPR program 107 may store (in sequential order) every user prompt of the interaction, and its associated response, in a graph/tree structure within storage 124 and/or remote database 130. Using the above interaction example as an illustration, UPR program 107 may store (e.g., within storage 124 and/or remote database 130) text of the sequential prompt-response history (i.e., P1-R1, P2-R2, P3-R3) in a graph structure.

At 208, according to at least one embodiment, UPR program 107 defines one or more tuple mappings for the approved response. More specifically, UPR program 107 may define a tuple mapping for each user prompt of the interaction to the approved response. Using the above interaction example as an illustration, UPR program 107 may define a tuple mapping for the text of P1 to the text of the approved response R3 ([P1→R3]), a tuple mapping for the text of P2 to the text of R3 ([P2→R3]), and a tuple mapping for the text of P3 to the text of R3 ([P3→R3]). Moreover, UPR program 107 may store the defined tuple mappings, [P1→R3], [P2→R3], and [P3→R3], within storage 124 and/or remote database 130 for subsequent access.

It should be noted that in at least one embodiment, UPR program 107 may separate or group submitted user prompts, and their associated responses, of one user interaction from another user interaction (e.g., submitted user prompts of an interaction may be grouped as a set). In such an embodiment, the separation or grouping may be based on a time lag or timing between prompt submissions by the user. For instance, user prompts submitted within a specified timing of each other may be grouped together as one user interaction with UPR program 107. The separation or grouping may also, or alternatively, be based on application, by UPR program 107, of NLP techniques (e.g., string metric analysis, semantic similarity with sentence embeddings, latent semantic analysis) on submitted user prompts to determine similarity among the user prompts. For instance, user prompts determined to be within a defined threshold of similarity may be grouped together as one user interaction with UPR program 107. Using the above interaction example as an illustration, UPR program 107 may group user prompts P1, P2, and P3, along with their respectively associated responses, as a set with P3 being the final user prompt of the set. The user prompts P1, P2, and P3, along with their respectively associated responses, may be grouped as a set based on a determined similarity among the user prompts.

Next, at 210, UPR program 107 extracts one or more topic-related keywords from the user submitted prompt associated with the user-approved response. According to at least one embodiment, UPR program 107 may perform the topic-related keyword extraction through tokenization+removal of stop words+ stemming of the submitted prompt associated with the user-approved response. According to at least one other embodiment, UPR program 107 may perform the topic-related keyword extraction using a topic extraction prompt (TEP) with the LLM. In such an embodiment, UPR program 107 may internally prompt the LLM using the following example TEP:
TEP: Extract keywords from the given content. Restrict yourself to the content provided. Do not invent things. Do not provide explanations. Show only the list of keywords identified in the provided content divided by comma. Next, I'll provide examples of how I want you to answer.

Answer yes when you are ready to receive a new content.
<example>
<content>What's XYZ</content>
<answer>XYZ</answer>
</example>
<example>
<content>I want you to do task A and extract B, C, and D.</content>
<answer>A, B, C, D</answer>
</example>

It should be noted that the above TEP is merely an example and that UPR program 107 may internally prompt the LLM using other versions of a TEP to perform the topic-related keyword extraction. Furthermore, it should also be noted that the given content of the above TEP is the text of the user submitted prompt associated with the user-approved response. In further continuation of the above interaction example, UPR program 107 may extract one or more topic-related keywords from the submitted prompt P3 associated with the user-approved response R3 using the following TEP and obtain the following topics:
TEP: Extract topics from: “List the steps for conducting audience research, followed by a guide on creating customer personas.”
   Topics: steps, audience research, guide, customer personas.

At 212, UPR program 107 generates an internal representation of the user submitted prompt associated with the user-approved response using a topic-guided reverse prompt. Reverse prompting is a technique where the starting point is a desired/approved LLM response and the LLM works backwards to create an input prompt that would generate the approved response. The LLM analyzes the target response's key elements and structure, then crafts a prompt likely to elicit those specific components from the model. According to at least one embodiment, UPR program 107 may utilize a reverse prompt which is guided by the topic-related keywords extracted in step 210 and the response determined as approved by the user in step 204 as inputs to generate an internal prompt representation for the topics and response evaluated as inputs. In other words, UPR program 107 may use a topic-guided reverse prompt to generate an internal representation of a better structured prompt (P+) given an approved response and topics identified in the user prompt associated with the approved response. Continuing with the ongoing interaction example, UPR program 107 may use the following topic-guided reverse prompt (TGRP) to produce the following internal prompt representation (P+) of the submitted prompt P3:
TGRP: Perform reverse prompting for the following response. Make sure your prompt considers only the topics provided. Your output must be only the reverse prompt. Do not provide explanations. Do not add nodes. Your prompt needs to be well structured and succinct.
   Topics: steps, audience research, guide, customer personas.
Response: Sure, here are the steps for conducting audience research: 1. Define your objectives: Clearly outline what you hope to achieve through your research. This could include understanding your target audience better, identifying new market opportunities, or testing product concepts. 2 . . . .
P+: Write a concise guide on the steps for conducting audience research and creating customer personas.
It should be noted that the above TGRP is merely an example and that UPR program 107 may generate an internal representation of the user submitted prompt associated with the user-approved response using other versions of a TGRP.

According to at least one other embodiment, at 212, UPR program 107 may generate multiple versions of internal representations of the user submitted prompt associated with the user-approved response using a topic-guided reverse prompt, i.e., UPR program 107 may generate multiple versions of P+ prompts. In such an embodiment, UPR program 107 may select the P+ prompt version which is most similar (e.g., determined to be within a defined threshold of similarity) to the user submitted prompt associated with the user-approved response. Alternatively, UPR program 107 may select the top-n P+ prompt versions which are most similar to the user submitted prompt associated with the user-approved response. UPR program 107 may utilize NLP techniques (e.g., edit distance analysis, Levenshtein distance analysis, semantic similarity with sentence embeddings, latent semantic analysis) to determine a similarity between a P+ prompt and the user submitted prompt associated with the user-approved response. Beyond similarity, other metrics which may also be considered by UPR program 107 include prompt length, perplexity score, and token length. Similarity metrics may also be established by an administrator and define specific similarity thresholds for specific business/use cases.

Next, at 214, UPR program 107 generates, via the LLM, an associated response to the internal prompt representation of the user submitted prompt associated with the user-approved response. According to at least one embodiment, UPR program 107 may prompt the LLM using the P+ generated at step 212 to obtain an associated response, R+. Additionally, at 212, UPR program 107 defines additional tuple mappings for the response R+ as well as for the user-approved response. Referring back to the above interaction example as an illustration, UPR program 107 may define a tuple mapping for the text of P1 to the text of response R+ ([P1→R+]), a tuple mapping for the text of P2 to the text of response R+ ([P2→R+]), a tuple mapping for the text of P3 to the text of response R+ ([P3→R+]), a tuple mapping for the text of P+ to the text of response R+ ([P+→R+]), as well as a tuple mapping for the text of P+ to the text of response R3 ([P+→R3]). According to at least one embodiment, UPR program 107 may store (e.g., within storage 124 and/or remote database 130) text of its self-generated prompt-response history (e.g., P+−R+, P1+−R1+, etc.) in a graph structure. UPR program 107 may also store the defined tuple mappings, [P1→R+], [P2→R+], and [P3→R+], within storage 124 and/or remote database 130 for subsequent access.

At 216, UPR program 107 fine-tunes the LLM based on defined tuple mappings.

According to at least one embodiment, UPR program 107 may re-instruct the LLM using the tuple mappings defined at steps 208 and 214, specifically, [P1→R3], [P2→R3], [P3→R3], [P1→R+], [P2→R+], [P3→R+], [P+→R+], and [P+→R3]. UPR program 107 may access the tuple mappings, defined and stored at 208 and 214, from storage 124 and/or remote database 130. Consequently, UPR program 107 may fine-tune the LLM to interpret and respond to less structured prompts, such as P1 and P2, with responses which are more accurate and useful to the user, such as R3 and R+; thereby improving the robustness of the LLM to submitted less structured user prompts by enabling the LLM to generate responses similar to those obtained by well-structured prompts. According to at least one embodiment, the steps of process 200 may be performed during a training phase of UPR program 107 and the fine-tuned LLM may be deployed for response generation during an implementation phase of UPR program 107. Further, it should be noted that at least steps 206-216 of process 200 are not visible to the user, i.e., UPR program 107 may process steps 206-216 automatically and internally in response to a determination that a generated response to an associated user prompt has been approved by the user.

It may be appreciated that FIG. 2 provides only an illustration of one implementation and does not imply any limitations with regard to how different embodiments may be implemented. Many modifications to the depicted environments may be made based on design and implementation requirements.

Furthermore, although process 200 of FIG. 2 was directed to improving robustness of a large language model in response to unstructured prompts, it should be noted that in other embodiments the inventive concepts of the present disclosure and the methodology of process 200 may be directed to improving robustness of other generative AI models (e.g., generative image, audio, and/or video models) to unstructured prompts. For example, in the context of a generative text-to-image model where images are output based on textual descriptions (i.e., text prompts), the methodology of process 200 may be applied to fine-tune the text-to-image model based on defined tuple mappings of text prompts to approved image outputs and defined tuple mappings of internally generated prompt representations to associated and/or approved image outputs. As another example, in the context of a generative text-to-audio model where an audio output (e.g., speech, music, sound effects) is generated in response to textual prompts, the methodology of process 200 may be applied to fine-tune the text-to-audio model based on defined tuple mappings of text prompts to approved audio outputs and defined tuple mappings of internally generated prompt representations to associated and/or approved audio outputs.

The descriptions of the various embodiments and use cases of the present invention have been presented for purposes of illustration, but are not intended to be exhaustive or limited to the embodiments disclosed. Many modifications and variations will be apparent to those of ordinary skill in the art without departing from the scope of the described embodiments. The terminology used herein was chosen to best explain the principles of the embodiments, the practical application or technical improvement over technologies found in the marketplace, or to enable others of ordinary skill in the art to understand the embodiments disclosed herein.

1. A computer-implemented method, the method comprising:
receiving a set of user prompts to a large language model (LLM);
generating, via the LLM, a respective associated response to each user prompt of the set;
determining a user-approved, associated response to a final user prompt of the set;
defining a respective tuple mapping for each user prompt of the set to the user-approved, associated response;
extracting one or more topic-related keywords from the final user prompt, wherein the one or more topic-related keywords are extracted by applying, via the LLM, a topic extraction prompt to the final user prompt;
generating, via the LLM, an internal prompt representation of the final user prompt using a topic-guided reverse prompt, wherein the topic-guided reverse prompt is generated, via the LLM, from the extracted one or more topic-related keywords and the user-approved, associated response;
generating, via the LLM, an associated response to the internal prompt representation;
defining respective tuple mappings for the internal prompt representation to the user-approved, associated response and to the associated response;
defining a respective tuple mapping for each user prompt of the set to the associated response; and
fine-tuning the LLM based on defined tuple mappings.

2. The method of claim 1, wherein determining a user-approved, associated response comprises a determination that an indication of approval has been received from a user, and wherein an indication of approval is based on an explicit or an implicit action of the user.

3. The method of claim 1, wherein a defined tuple mapping maps text of an LLM prompt to text of an LLM response.

4. (canceled)

5. (canceled)

6. The method of claim 1, further comprising:
generating, via the LLM, multiple versions of the internal prompt representation of the final user prompt using the topic-guided reverse prompt; and
selecting a version of the multiple versions as the internal prompt representation based on a semantic similarity score of the version to the final user prompt satisfying a defined threshold, wherein the semantic similarity score is determined using at least one natural language processing (NLP) technique selected from a group consisting of edit distance analysis, Levenshtein distance analysis, semantic similarity with sentence embeddings, and latent semantic analysis on the version and the final user prompt.

7. The method of claim 1, wherein the user prompts are grouped as the set based on a semantic similarity score among the user prompts, the semantic similarity score being determined using at least one natural language processing (NLP) technique selected from a group consisting of string metric analysis, semantic similarity with sentence embeddings, and latent semantic analysis, and the grouping being based on the semantic similarity score satisfying a defined threshold.

8. A computer system, the computer system comprising:
one or more processors, one or more computer readable memories, one or more computer readable storage medium, and program instructions stored on at least one of the one or more computer readable storage medium for execution by at least one of the one or more processors via at least one of the one or more memories, wherein the computer system is capable of performing a method comprising:
receiving a set of user prompts to a large language model (LLM);
generating, via the LLM, a respective associated response to each user prompt of the set;
determining a user-approved, associated response to a final user prompt of the set;
defining a respective tuple mapping for each user prompt of the set to the user-approved, associated response;
extracting one or more topic-related keywords from the final user prompt, wherein the one or more topic-related keywords are extracted by applying, via the LLM, a topic extraction prompt to the final user prompt;
generating, via the LLM, an internal prompt representation of the final user prompt using a topic-guided reverse prompt, wherein the topic-guided reverse prompt is generated, via the LLM, from the extracted one or more topic-related keywords and the user-approved, associated response;
generating, via the LLM, an associated response to the internal prompt representation;
defining respective tuple mappings for the internal prompt representation to the user-approved, associated response and to the associated response;
defining a respective tuple mapping for each user prompt of the set to the associated response; and
fine-tuning the LLM based on defined tuple mappings.

9. The computer system of claim 8, wherein determining a user-approved, associated response comprises a determination that an indication of approval has been received from a user, and wherein an indication of approval is based on an explicit or an implicit action of the user.

10. The computer system of claim 8, wherein a defined tuple mapping maps text of an LLM prompt to text of an LLM response.

11. (canceled)

12. (canceled)

13. The computer system of claim 8, the method further comprising:
generating, via the LLM, multiple versions of the internal prompt representation of the final user prompt using the topic-guided reverse prompt; and
selecting a version of the multiple versions as the internal prompt representation based on a semantic similarity score of the version to the final user prompt satisfying a defined threshold, wherein the semantic similarity score is determined using at least one natural language processing (NLP) technique selected from a group consisting of edit distance analysis, Levenshtein distance analysis, semantic similarity with sentence embeddings, and latent semantic analysis on the version and the final user prompt.

14. The computer system of claim 8, wherein the user prompts are grouped as the set based on a semantic similarity score among the user prompts, the semantic similarity score being determined using at least one natural language processing (NLP) technique selected from a group consisting of string metric analysis, semantic similarity with sentence embeddings, and latent semantic analysis, and the grouping being based on the semantic similarity score satisfying a defined threshold.

15. A computer program product, the computer program product comprising:
one or more computer readable storage medium and program instructions stored on at least one of the one or more computer readable storage medium, the program instructions executable by a processor capable of performing a method, the method comprising:
receiving a set of user prompts to a large language model (LLM);
generating, via the LLM, a respective associated response to each user prompt of the set;
determining a user-approved, associated response to a final user prompt of the set;
defining a respective tuple mapping for each user prompt of the set to the user-approved, associated response;
extracting one or more topic-related keywords from the final user prompt, wherein the one or more topic-related keywords are extracted by applying, via the LLM, a topic extraction prompt to the final user prompt;
generating, via the LLM, an internal prompt representation of the final user prompt using a topic-guided reverse prompt, wherein the topic-guided reverse prompt is generated, via the LLM, from the extracted one or more topic-related keywords and the user-approved, associated response;
generating, via the LLM, an associated response to the internal prompt representation;
defining respective tuple mappings for the internal prompt representation to the user-approved, associated response and to the associated response;
defining a respective tuple mapping for each user prompt of the set to the associated response; and
fine-tuning the LLM based on defined tuple mappings.

16. The computer program product of claim 15, wherein determining a user-approved, associated response comprises a determination that an indication of approval has been received from a user, and wherein an indication of approval is based on an explicit or an implicit action of the user.

17. The computer program product of claim 15, wherein a defined tuple mapping maps text of an LLM prompt to text of an LLM response.

18. (canceled)

19. (canceled)

20. The computer program product of claim 15, the method further comprising:
generating, via the LLM, multiple versions of the internal prompt representation of the final user prompt using the topic-guided reverse prompt; and
selecting a version of the multiple versions as the internal prompt representation based on a semantic similarity score of the version to the final user prompt satisfying a defined threshold, wherein the semantic similarity score is determined using at least one natural language processing (NLP) technique selected from a group consisting of edit distance analysis, Levenshtein distance analysis, semantic similarity with sentence embeddings, and latent semantic analysis on the version and the final user prompt.
